(19) United States
(12) Patent Application Publication
(10) Pub. No.: US 2005/0128752 A1
(43) Pub. Date: Jun. 16, 2005

(54) Lighting module

(76) Inventors: Christopher Daniel Ewington, Manchester (GB); James Albert Powell, Cheshire (GB)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(21) Appl. No.: 10/969,389

(22) Filed: Oct. 20, 2004

(30) Foreign Application Priority Data
Apr. 20, 2002 (GB) GB 0209069.4

(51) Int. Cl. F21V 29/00

(52) U.S. Cl. 362/294

(57) ABSTRACT

A lighting module comprising a light source arranged to emit light and a cooling chamber, which is provided adjacent to the light source. The cooling chamber is open to the atmosphere surrounding the light module but substantially sealed from the light source. The light source may comprise one or more light emitting diodes (LEDs).

This invention relates to a lighting module and related methods, and in particular, but not exclusively to lighting modules relying on LED light sources.

The use of LED's have a number of advantages over traditional filament bulbs: more rapid switching, more robust, increased life, lower power consumption, little heat transmitted in a forward direction. Therefore, although clearly advantageous a design parameters compared to filament light bulbs have changed.

With improvements in LED technology various new applications (for example traffic signals, car brake and indicator lights) are now being converted to LED based illumination with obvious maintenance and running cost savings.

This although described with reference to LED light sources may have wider applicability. With the advent of the blue LED in the 1990's it became possible to generate white light using a combination of red, green and blue LED's. Further, with the recent introduction of new, brighter blue and green LED's, when placed along existing high brightness red LED's (used predominantly in automotive high level brake lights) it is possible to mix the three basic primary colours.

The use of LED's may be widely applied to a variety of different fields as will be described herein. Examples of such LED technology can be found in patents such as WO 99/10867 and U.S. Pat. No. 6,211,626.

One area in which prior art filament lights have previously been used is stage lighting with an average stage using groups of lights for illumination. Such filament based lights projected a large amount of heat forwards and required colour filters to alter the colour of the light emitted therefrom. The colour filters were subject to heat deterioration and usually the deeper or more saturate a colour chosen, the greater the need to continually replace the filter. This was a common problem faced by long running performances.

Lighting systems, which use incandescent light bulbs to illuminate, may be connected to high current dimmer circuits. The dimmer circuits are normally located remote to the light fittings for ease of maintenance. Each light fitting may be wired to individual dimmer circuits, which require a suitable connection between the dimmer and the light fitting. With lighting systems sometimes using hundreds of dimmer circuits, there is substantial investment required to provide individual connection between each light fitting and dimmer. This has an impact on set-up of such systems, especially when portable lighting systems require extra time to install the electrical circuits using flexible cables.

Incandescent sealed beam light bulbs, when controlled via a current control (dimmer) device the lamp colour temperature varies as the current applied is reduced. This has the effect of changing from white light to yellow the dimmer the light intensity becomes.

Furthermore as the lighting industry improves working conditions, prior art filament based light may have a surface temperature of in excess of 200 degrees Celsius. This has an impact in which lights are chosen for aesthetic reasons, but also for risk assessment which can precludes prior art filament based lights from certain applications, without serious consideration placed on the heat dissipation problems.

The sealed beam bulb sometimes used in prior art filament based lights burns brighter than average bulbs, which radically affects the lifetime of a lamp. An average domestic bulb will be designed to last up to 2000 hours. The sealed beam prior art filament based light has an average lamp life of 400 hours. This can be greatly reduced if the lamp is repeatedly being flashed from zero intensity to full intensity. Once the lamp has been in operation the filament is exceptionally fragile and requires time to cool down before the unit can be moved. This problem obviously impacts on the cost of touring lighting systems, which may be in a different venue every night. Touring costs are further increased when lamp checking and replacement slows down the set-up procedures.

Lamps can also fail, when installed above the performance space, which require replacing before a show. Consequently, further risk is placed on the lighting personnel, who have a duty to ensure that all the lights work.

In some embodiments, the present invention takes advantage of light emitting diodes (LED's) which when disposed on a circuit board in a matrix arrangement, projects an alternative beam of light previously achieved with the sealed beam incandescent bulbs.

According to a first aspect of the invention there is provided a lighting module comprising a light source arranged to emit light and a cooling chamber being provided adjacent the light source with the cooling chamber being open to the atmosphere surrounding the lighting module, but substantially sealed from the light source.

An advantage of such an arrangement is that the light source is provided with cooling via the cooling chamber, but can be placed in outside environments without the light module being affected by moisture, etc.

The light source may be arranged to emit light generally in front of a plane through the source. The cooling chamber may be arranged on a side of the light source substantially opposite the side which is generally arranged to emit light.

The cooling chamber may have a heat sink arranged therein, preferably with one or more cooling fins arranged thereon. Such an arrangement is convenient because it provides an efficient structure for removing unwanted heat.

In a preferred embodiment the light source is mounted on a surface of the heat sink, preferably on a side opposite the one or more cooling fins that are provided.

The at least one cooling fin preferably extends into the cooling chamber. Such an arrangement is advantageous because the fin is exposed to the atmosphere that exists within the cooling chamber which is open to the atmosphere surrounding the lighting module. Therefore, an efficient method of removing heat from the light source is provided.

A fan (or other fluid moving means for example a pump, etc.) may be provided to assist the movement of fluid (generally gas, and in particular air) from outside of the lighting module into the cooling chamber. Such an arrangement is convenient because is assists in the cooling of the light source.

The cooling chamber may be divided into an inlet and an outlet region, possibly by a plate, or like member, arranged across the cooling chamber. The inlet region may be arranged to intake fluid from the atmosphere surrounding the lighting module. The outlet region may be arranged to have fluid expelled therefrom to the atmosphere surrounding the lighting module. Generally the inlet region is arranged adjacent the heat sink providing efficient cooling thereof.

Conveniently, the fluid moving means is arranged to move fluid from the inlet region to the outlet region.

In a preferred embodiment of the invention the inlet region and outlet region are arranged such that, in the usual operating position of the lighting module, the outlet region is generally above the inlet region. It will be appreciated that such an arrangement is convenient because it allows fluid heated by a heat sink in the inlet region to move by convection into the outlet region, thereby helping to improve the cooling efficiency of the light source.

A thermostat may be provided and arranged to control the fluid moving means. Such an arrangement is convenient because it allows the fluid moving means to operate only when required.

The lighting module may comprise an electronics containing chamber arranged to contain electronics used in powering and controlling the light source.

Preferably, the cooling chamber is between the light source and the electronics chamber. Such an arrangement is advantageous because it allows the light source to be cooled.

The cooling chamber may be sealed from the light source to an appropriate Ingress Protection rating. Further, the electronics chamber may be sealed from the cooling chamber to an appropriate Ingress Protection rating.

Preferably, the cooling chamber may be sealed from the light source to Ingress Protection rating IP54. Further, the electronics chamber may be sealed from the cooling chamber to Ingress Protection rating IP54.

The heat sink may be mounted on a wall fabricated from a heat conducting material of the lighting module such that heat can be conducted to the wall. The wall is preferably fabricated from a metal. In preferred embodiment the wall is fabricated from aluminium, but it will be appreciated that other metals such as steel, titanium, magnesium or the like may be suitable. The wall may be an external wall of the lighting module. Such an arrangement is convenient because it uses the wall to absorb heat from the light source and therefore helps to cool the light source.

Conveniently, the heat sink is sealed to the wall using a heat conductive sealing material. Such an arrangement is convenient because it helps to prevent the ingress of moisture from the cooling chamber.

The sealing material may be a heat conductive rubber. An appropriate seal is manufactured by Berquist UK Ltd of Unit 27 Darin Court, Crownhill Industrial Estate, Milton Keynes, MK80AD. Or an alternative supplier is Thermagon, Inc. 4707 Detroit Ave., Cleveland, Ohio.

The lighting module may comprise a circuit board having a thermally conductive layer. Conveniently, the thermally conductive layer is in thermal contact with a heat sink, which is preferably the wall of the housing.

The heat sink may comprise a housing of the lighting module.

According to a second aspect of the invention there is provided a lighting module comprising a light source arranged to emit light and a cooling chamber the light source being mounted adjacent an inlet region of the cooling chamber which is arranged to inlet cooling fluid and pass the cooling fluid to an outlet region wherein the inlet and outlet regions are arranged such that, in the usual operating position of the lighting module, the outlet region is generally above the inlet region.

It will be appreciated that such an arrangement is convenient because it allows fluid heated by the light source in the inlet region to move by convection into the outlet region, thereby helping to improve the cooling efficiency of the light source.

Generally, a fluid moving means, usually a fan, is provided and arranged to move cooling fluid from the inlet region into the outlet region. Such an arrangement assists the cooling provided by the convection cooling.

The light source may be mounted on a heat sink. The heat sink may have cooling fins that extend into the inlet region. It will be appreciated that cooling fins are advantageous because they maximise the area available for heat exchange.

In one of the preferred embodiments the cooling fins are arranged such that cooling fluid entering the inlet region passes over the cooling fins. Such an arrangement is convenient because it helps to maximise cooling.

A thermostat may be provided and arranged to control the fluid moving means. Such an arrangement is convenient because it allows the fluid moving means to operate only when required.

The lighting module may comprise an electronics containing chamber arranged to contain electronics used in powering and controlling the light source.

Preferably, the cooling chamber is between the light source and the electronics chamber. Such an arrangement is advantageous because it allows the light source to be cooled.

The cooling chamber may be sealed from the light source to an IP54 rating. Further, the electronics chamber may be sealed from the cooling chamber to an IP54 rating.

The electronics chamber may contain a power supply unit, which may be mounted upon a wall between the cooling chamber and the electronics chamber. An advantage of such an arrangement is that cooling fluid passing through the cooling chamber helps to keep the power supply unit cooled.

The heat sink may be mounted on a wall fabricated from a heat conducting material of the lighting module such that heat can be conducted to the wall. The wall is preferably fabricated from a metal. In preferred embodiment the wall is fabricated from aluminium, but it will be appreciated that other metals such as steel, titanium, magnesium or the like may be suitable. The wall may be an external wall of the lighting module. Such an arrangement is convenient because it uses the wall to absorb heat from the light source and therefore helps to cool the light source.

Conveniently, the heat sink is sealed to the wall using a heat conductive sealing material. Such an arrangement is convenient because it helps to prevent the ingress of moisture from the cooling chamber.

The sealing material may be a heat conductive rubber.

One or more holes may be provided in an external wall of the lighting module, which communicate with the cooling chamber. Preferably, there are a plurality of holes.

A portion of each hole may be arranged to communicate with the inlet region, and a portion of each hole may be arranged to communicate with the outlet region (i.e. any hole that is provided may span both the inlet and outlet regions). Such an arrangement is convenient because it provides a structure that is simple to manufacture.

A plate may be provided to substantially separate the inlet and outlet regions. The fluid moving means may be provided within the plate.

The lighting module may comprise a circuit board having a thermally conductive layer. Conveniently, the thermally conductive layer is in thermal contact with a heat sink, which is preferably the wall of the housing.

The heat sink may comprise a housing of the lighting module.

According to a third aspect of the invention there is provided a lighting module comprising a light source mounted upon a heat sink wherein the heat sink is mounted on a wall of the lighting module which is fabricated from a heat conducting material such that heat can be conducted to the wall.

Such an arrangement is convenient because it uses the wall of the lighting module as a heat sink which helps to remove heat from the light source.

The wall may be an external wall of the lighting module, and may be fabricated from a metal. Conveniently, the metal is aluminium, but it may also be fabricated from any one of the following metals: steel, magnesium, titanium.

Alternatively, or additionally, the wall may be fabricated from a heat conductive plastics material.

A fluid moving means may be provided in order to move cooling fluid through the lighting module. In particular the fluid moving means may be a fan, a pump, or the like.

The lighting module may comprise a spun aluminium body, which may be substantially cylindrical in cross section. The body may have a domed, closed, end, and may have an open end through which light is transmitted.

Use of a heat conducting wall in this manner may mean that sufficient cooling may be achieved without a fluid moving means. Clearly, the omission of a fluid moving means will in general reduce the power consumption of the lighting module, which in itself is advantageous.

Various features have been introduced, and their advantages discussed, in relation to each of the first, second and third aspect of the invention. The skilled person will appreciate that features discussed in relation to any one of these aspects of the invention are in general equally applicable to the other two aspects of the invention and have not been discussed in relation to each of the aspects in the sake of brevity.

The following features may be applicable in any of the first, second or third aspects of the invention detailed above.

The light source may comprise an LED light source, which preferably comprises one or more of each of a red, green and blue LED.

A controller may be provided and arranged to control the LED's. The controller may be arranged to control each LED of a particular colour together (e.g. all the red, all the green, all the blue), or may be arranged to address individual LED's, or any stage between these two extremes.

In such an embodiment the LED's may be arranged to be controlled to vary the intensity of the light emitted by any one colour of LED. Such an arrangement is advantageous because it allows the colour emitted by the lighting module to be varied and eliminates the need to use colour filters and can greatly enhance the choice of colour from the module.

The controller may be arranged to vary the intensity of a colour of LED by modulating the current supplied to the LED. The intensity of the LED may be adjusted by the use of constant current source known as Direct Linear Drive (DLD) known by people skilled in the art. The modulation scheme may provide a plurality of discrete colour intensities for each colour. For example roughly any of the following colour intensities may be provided: 64, 128, 256, 512, 1024, 2000, or any number in between any of these colour intensities.

The generation of the desired colour by the appropriate control of the LED's is advantageous because the light projected equates to a more efficient process than use of prior art filament bulbs and filters—prior art colour filter and bulb arrangements absorbed the white light, by subtracting out the other colours within the full colour spectrum. The use of three colours of LED uses additive colour mixing. This may result in a substantial saving to running costs compared with prior art bulb/filter arrangements. A further advantage of LED's controlled in this manner is that the colour remains constant as the current applied to the LED's is varied by way of the control.

A user interface may be provided allowing the controller to be manually programmed.

In alternative, or additional embodiments the controller may be programmed from device remote to the lighting module. For example, the controller may be programmed by downloading information into the controller, perhaps specific for the intended application.

Further, the controller may be programmed with pre programmed current control sequences thereby allowing the lighting module to generate fixed sequences of illumination.

The LED's may be of the polymer encapsulated through hole type or of the surface mount type.

The lighting module may comprise a circuit board having a thermally conductive layer. Conveniently, the thermally conductive layer is in thermal contact with a heat sink, which is preferably the wall of the housing.

The heat sink may comprise a housing of the lighting module.

The wall and/or housing of the heat sink may comprise an extrusion which provides a robust, yet cost effective means of providing the housing.

Conveniently, the heat conducting layer may comprise a metallic layer, which metal may be copper.

Components, such as the light source, may be mounted on the circuit board such that they pass through the heat conducting layer without contacting it.

According to a fourth aspect of the invention there is provided a method of cooling a light source comprising mounting the light source adjacent a cooling chamber which is open to the atmosphere surrounding the lighting module, but substantially sealed from the light source.

According to a fifth aspect of the invention there is provided a method of cooling a light source comprising providing a cooling chamber and mounting a light source adjacent thereto, and arranging the cooling chamber such that it comprises an inlet region adjacent the light source arranged to inlet cooling fluid and an outlet region arranged to expel cooling fluid and arranging the inlet and outlet region such that, in the usual operating position of the lighting module, the outlet region is generally above the inlet region.

According to a sixth aspect of the invention there is provided a method of cooling a light source comprising mounting the light source upon a heat sink and further mounting the heat sink on a wall of a lighting module containing the light source and fabricating the wall from a heat conducting material such that heat can be conducted to the wall.

According to a seventh aspect of the invention there is provided a lighting module comprising a light source mounted upon a circuit board wherein the circuit board comprises a heat conducting layer arranged to dissipate heat from the light source.

The heat conducting layer may be thermally connected to a heat sink.

The heat sink may comprise a housing of the heat sink.

The housing of the heat sink may comprise an extrusion which provides a robust, yet cost effective means of providing the housing.

Conveniently, the heat conducting layer may comprise a metallic layer, which metal may be copper.

Components, such as the light source, may be mounted on the circuit board such that they pass through the heat conducting layer without contacting it.

An embodiment of the invention is now described by way of example only and with reference to the accompanying figures of which:—

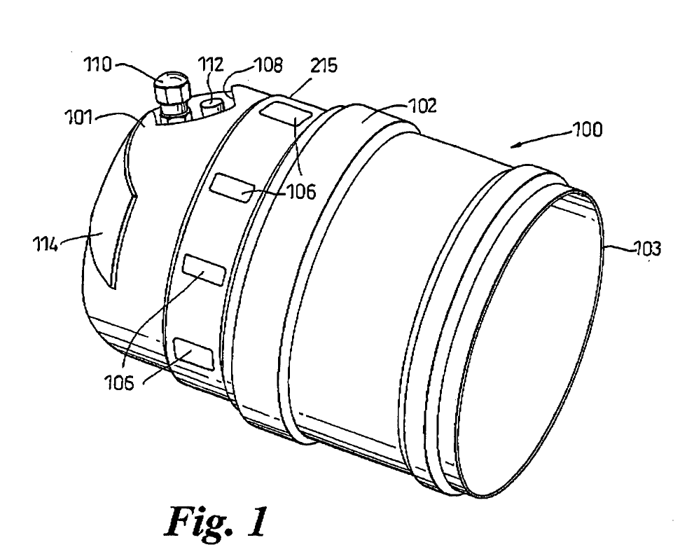

FIG. 1 shows a perspective view of a lighting module according to a first embodiment of the present invention;

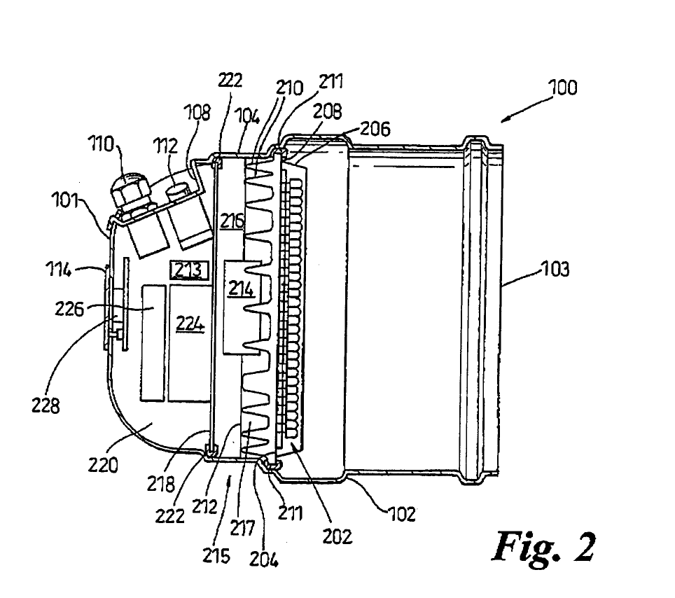

FIG. 2 shows a side-on sectional view of a lighting module according to the first embodiment of the present invention;

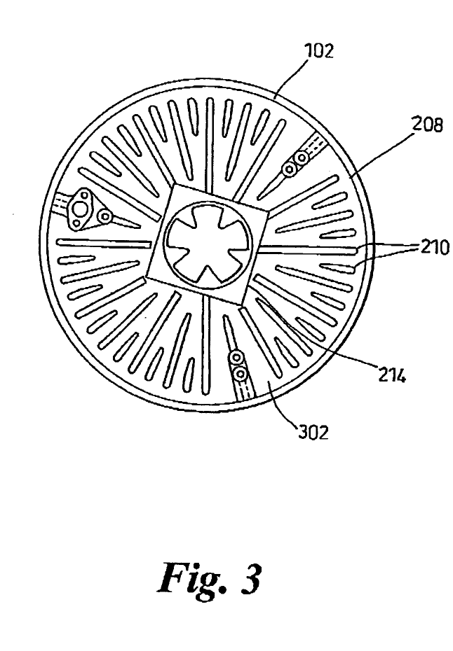

FIG. 3 shows an end-on sectional view of a lighting module according to the first embodiment of the present invention;

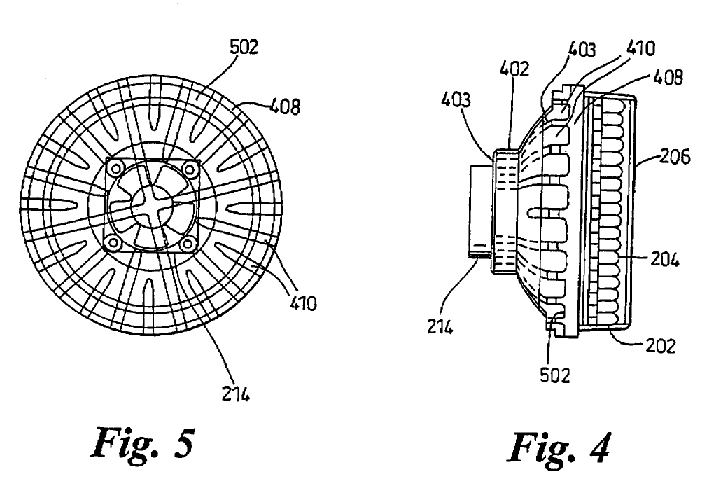

FIG. 4 shows a side-on sectional view of a lighting module according to a second aspect of the invention;

FIG. 5 shows an end-on sectional view of a lighting module according to the second embodiment of the invention;

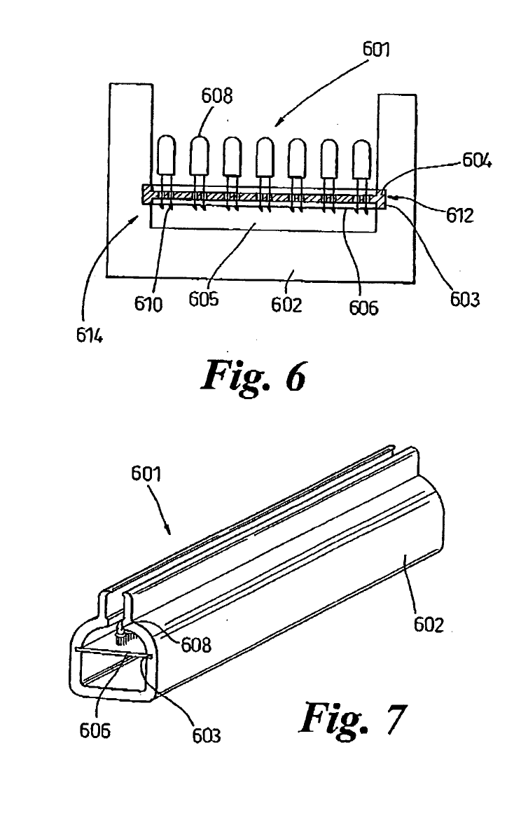

FIG. 6 shows a cross section through a further embodiment of the invention; and

FIG. 7 shows a perspective view of the embodiment shown in FIG. 6.

FIG. 1 shows first embodiment of a lighting module 100 suitable for use as a spotlight at, for example, an open-air music concert. The lighting module 100 comprises an approximately cylindrical casing 102 having a first, closed, end 101 and a second, open, end 103 opposite the first. The casing is a spun aluminium, often referred to as a par can, construction providing weight advantages over other folded steel constructions. The casing 102 includes a cooling chamber 215 along a portion of its length roughly midway between the first and second ends. The casing 102 comprises a domed portion in the vicinity of the closed end 102 which continues the roughly cylindrical casing 102.

The cooling chamber 215 is defined by an area of the casing 102 with holes 106 equi-spaced about the circumference of the casing 102. A portion of the dome forming the closed end 101 of the casing 102 is cut away and an insert 108, providing a plate onto which connectors can be mounted, is placed therein. The insert 108 comprises a plastic support through which a network connector 110 and a power connector 112 pass in order that connections can be made to electronics contained within the casing 102. The closed end 101 of the casing 102 further comprises a second cut-away portion over which a touch panel 114 is placed such that a user may, by touching the touch panel 114, control electronics within the casing 102. The touch panel 114 may be constructed of Mylar, or of some other material for use in a touch-sensitive control device.

The interior of the casing 102 is now described with reference to FIG. 2. As FIG. 2 shows a cross-sectional view of the lighting module 100 shown in FIG. 1, like features are labelled with like numbers.

The lighting module 100 comprises a Light Emitting Diode (LED) array 202 providing a light source and arranged on a circuit board 204 mounted perpendicularly to a longitudinal axis of the lighting module 100 such that in use the light produced by the LED array 202 is directed towards the open end 103 of the casing 102. The circuit board 204 upon which the array is mounted lies on a plane and the array projects light generally in front of the circuit board. The lighting module has a typical life of 100 000 hours. The circuit board 204 is situated at an edge region of the cooling chamber 215 towards the open end 103. The LED array 202 comprises a plurality of polymer encapsulated LED's and in this example, six hundred and twenty LED's are provided.

Roughly two hundred LED's are provided of each red (i.e. produce red light when a current is applied), blue and green. The light from the LED array 202 passes through an acrylic dust cover 206 which is bonded to the circuit board 204 and also seals the LED array 202 such that moisture cannot contact the array 202 through the open end 103 of the casing 102. The circuit board 204 is backed on to and in thermal contact with a heat exchanger 208. The heat exchanger 208 is also shown in FIG. 3 and comprises a planar surface 302 to which a rear face (i.e. opposite the LED array 202) of the circuit board 204 is attached. The side of the heat exchanger 208 opposite the planar surface comprises a plurality of raised fins 210 which are arranged to project into the cooling chamber 215. The heat exchanger 208 is in thermal contact with the housing 102 via a moisture-proof but thermally conductive rubber seal 211. The rubber seal 211 isolates the circuit board 204 and the LED array 202 from the cooling chamber 215 which is open to the atmosphere. The rubber seal 221 is a gasket seal and provides an Ingress Protection rating or IP54 between the cooling chamber 215 and an electronics chamber 220 described below.

The fins 210 project into the ventilating area, or cooling chamber, of the casing 102 such that air passing through the holes 106 will circulate about the fins 210 thereby facilitating heat exchange between the fins 210 and the air.

The cooling chamber 215 is divided into two areas by a circular baffle plate 212, fabricated from aluminium and placed across substantially the entirety of the cross-section of the lighting module 100. The baffle plate 212 is arranged such that it lies roughly midway across the holes 106 in the casing 102, abuts the casing around substantially the entire circumference and so divides the ventilation area into two. The baffle plate 212 comprises a solid plate with a centre portion removed in which a fluid moving means, in this example a fan 214, (shown in both FIG. 2 and FIG. 3) is placed.

The cooling chamber 215 is divided in two separated by the baffle plate 212 to produce an inlet region 217, which contains the fins 210 of the heat exchanger 208, and an outlet region 216. The fan 214 is arranged such that air is drawn into the inlet region 217 of the cooling chamber 217, through the holes 106, passes through the fan 214, into the outlet region 216 and is expelled through the holes 106. Thus, the fins 210 are cooled by air being drawn across them, which in turn removes heat from the circuit board 204 and the LED array 202 mounted on the circuit board 204.

Electronics to control the lighting module 100 are contained within an electronic chamber 220 which are separated from the cooling chamber 215 by a partition plate 218 and the dome shaped portion of the casing 102 towards the closed end 101 thereof. The partition plate 218 has about its circumference a moisture-tight seal 222 sealing it to the casing 102 to isolate the electronics chamber 220 from the cooling chamber 215, which is open to the atmosphere through the holes 106. Thus, the lighting module 100 may be thought of as comprising three areas: The water tight area in which the LED array 202 is mounted between the planar surface of the heat exchanger 208 and the dust cover 206; the cooling chamber 215 which is open to the atmosphere through the holes 106; and the electronics chamber 220 between the domed portion of the casing and the partition plate 218. The two sealed areas are sealed to IP54 rating, as is the fan 214.

The electronics chamber 220 contains a power supply unit 224, a controller 226, a thermostat 213 and a user interface unit 228, all of which run at twenty four volts (as does the fan 214). Thus, when the lighting module 100 is running on full intensity for each of the red, green and blue LED's power consumption is seventy watts. The power supply unit 224 is connected to the power connector 112 and to the controller 226. An external current source is then connected to the power connector 112. The controller 226 is a computer processor and is arranged to receive instructions via the network connector 110 and/or from the user interface unit 228. The user interface unit 228 receives inputs from the user via the touch panel 114. The controller 226 is further arranged to receive inputs from the thermostat 213 to control the fan 214 and to control the LED array 202 via the circuit board 204. Wires to the LED array 202 pass from the electronics chamber 220 to the array 202 through the partition plate 218, the baffle plate 212 and the heat exchanger 208 and apertures through these plates/heat exchangers are sealed to ensure the array 202 and the electronics chamber 220 remain sealed.

The power supply unit 224 is mounted on the partition plate 218 so that cooling fluid circulating in the cooling chamber 215 cools the plate 218 and consequently helps to cool the power supply unit 224.

It will be appreciated that the cooling chamber 215 is open to the atmosphere, and therefore to rain and moisture and therefore provides a “wet-zone”. Further, in outdoor use of the lighting module 100, a plastic outer shroud will be used at least about the insert 108 to ensure that the electronics chamber 220 is kept dry. Equally, the rubber seal 211 is vital to protect the circuit board 204 and the LED array 202 from the “wet-zone” ventilation area.

In use of the lighting module 100, colour and brilliance of the light produced by the lighting module 100 may be controlled by the controller 226 according to instructions received either via the network connector 110 or via user inputs made using the touch panel 114 and transmitted to the controller 226 by the user interface unit 228. The controller 226 sends a signal to the circuit board 204 containing instructions as to which LED's should be lit. The skilled person will appreciate that LED's can be thought of as digital devices; they are either on or off. Therefore, to control the brightness of the LED the current to the LED is modulated in a manner to cause the LED to output the desired amount of light.

In this example, where the LED array 202 comprises six hundred and twenty LED's a third of which are blue, a third green and a third red, the colour of light produced by the lighting module 100 can be selected and altered. For example, the lighting module 100 may be required to provide white light, in which case the LED's of each colour group should be lit to equal brilliance. In this example, the controller 226 can cause the power supply unit 224 to provide current to produce a lighting module intensity of up to 4500 Lux, equivalent to a 500 watt sealed beam parabolic bulb. Each colour of LED can be controlled by altering the intensity of that colour LED (i.e. the intensity of the red, green and blue LED's can be altered independently from one another). Thus, any colour can be made by altering the intensity of the light emitted by one of the three colours of LED's. In this embodiment the controller 226 is capable of setting the brightness of each colour of LED to roughly 4096 distinct levels of brightness when run in 12 bit operation giving roughly 6.7 billion (4096×4096×4096) different colour outputs from the lighting module.

Historically the colour of light emitted from a lighting module has been controlled by introducing a plastic colour filter, it became possible to change the colour of the light by way of absorbing, or reflecting all other light than the specific colour chosen. Colour filter scrollers are also known which give a degree of alternative colour choice than one fixed colour. A disadvantage with these known solutions is that the colour of the filter can degrade when exposed to the heat emitted from traditional bulbs (especially of the sealed glass parabolic reflector type light source that helped to create a high light output device but also projected the heat forwards). Further, incandescent sealed beam light bulbs (as in the prior art), when controlled via a current control (dimmer) device the lamp colour temperature varies as the current applied is reduced. This has the effect of changing white light to yellow light the dimmer the light intensity becomes. Thus, the present arrangement removes the need for colour filters to change the light colour.

As further examples, the lighting modules 100 could be used to provide a “strobe” effect by switching the LED's on and off in unison several times a second; it will be appreciated that LED's have fast switching times when compared to bulbs. Alternatively, the red LED's could exclusively be lit such that the lighting module 100 produces red light. As a further example, the lighting module 100 could produce a green-and-blue flashing light by the controller 226 instructing that the green LED's then the blue LED's be lit in cyclic succession.

The controller 226 is capable of being programmed with a current control sequence such that the intensity and colour of the light produced by the lighting module 100 may be controlled according to a pre-set sequence. The current control sequence is input via the touch panel 114 and the user interface 228, or via a network connection utilising the network connector 110, establishing a binary data network.

The controller 226 also sends a signal to the fan 214, which operates to provide an air-cooling system as described above when the thermostat 213 records a temperature of at least predetermined value. It will, however, be appreciated by those skilled in the art that the fan 214 may not be controlled according to temperature. It may, for example, operate at all times, or for set periods of time, when the lighting module 100 is in use.

It will be further appreciated that many uses of the lighting module 100, such as for stage lighting, will require the lighting module 100 to be orientated such that the light is directed in a generally downwards direction. This has the effect that the heat exchanger 208 occupying the cooling chamber 215 will be often in use below the exhaust area 216. Due to convection, this arrangement of the heat exchanger 208 is advantageous due to the extra cooling that will occur.

The heat exchanger 208 is in thermal contact with the aluminium casing 102 through the thermally conductive rubber seal 211 such that the surface of the casing 102 is effectively part of the heat exchanger 208. This greatly increases the surface area available for cooling and again helps remove unwanted heat from the lighting module 100. It will be appreciated that a problem with prior art lights is that the casing can become excessively hot and maximising the area for heat exchange helps to reduce the temperature of the casing 102.

The lighting module 100 provides a source of coloured light without the need for filters. It can be used outdoors without modification and provides a practical alternative to traditional ‘spot light’ with a long life span and a low surface temperature.

If the lighting module 100 is to be used in external locations and is to be positioned to illuminate vertically upwards, a poly-carbonate cover should be placed over open end 103 to prevent liquids, for example rain water, from collecting within the lighting module 100.

The controller 226 makes use of the DMX 512 protocol, which created a stream of data, produced by a lighting computer connected to a series of remote theatrical fittings, which could typically be lighting modules 100.

The controller 226 is capable of generating DMX 512 protocol to control the device independent of connection to a computer network. The controller 226 transmits DMX 512 protocol (via the DMX out connection 110). The controller 226 is so designed to allow DMX 512 to be supplied via an external controller when connected to a network and addressed via the user interface 228 to run in “slave” mode.

The DMX 512 protocol was originally designed as a replacement to analogue based electronics requiring individual connection of each circuit (sometimes numbering hundreds of circuits), which delivered the signal from a remote lighting computer to the dimmer System. The DMX 512 protocol standardised differing protocols offered by different manufacturers.

DMX 512 protocol enables 512 individual control channels to be fed down one single data cable. Originally designed to improve communication between computer and dimmers.

With the advent of new robotic lights, all manufacturers adopted the DMX protocol as the industry standard.

The DMX protocol employs digital signal codes, when the lighting computer transmits a digital code a receiving device such as a dimmer, robotic light or other lighting devices, transforms the code into a function or command.

In hardware terms, the DMX protocol is delivered over metal data cables via the RS 485 hardware protocol, providing a bi-directional data link. The data cable consists usually of a twisted pair surrounded by an outer screen (earth) or shield. The first wire is known as data+ and the second as data.

DMX 512 protocol is normally transmitted at 250,000 bits per second over cable distances of hundreds of meters. Every byte transmitted has one start bit, normally used to ‘warn’ the remote device that the next start character is being sent. Eight data bits and two further stop bits are then sent. This roughly equates to the duration of each character is 44 microsecond.

The receiving device is addressed to a number between 1 and 512. The receiving device will then only respond to the data that is specific to that device within the binary data tree connected to the computer network.

The second embodiment of the invention has some features in common with the first aspect described above. In the Figures, these like features are labelled with like numbers.

The second lighting module 400 now described is shown in FIG. 4 as comprising a funnel-shaped casing 402 having two opposing open ends: a wide end 401 and a narrow end 403. The funnel-shaped casing 402 is spun aluminium, as before.

A fan 214 as described in reference to the first embodiment (shown in both FIG. 4 and FIG. 5) is placed in the narrow end 403.

Inside the funnel-shaped casing 402 from the wide end 401 is partially inserted a frusto conical heat exchanger 408. The heat exchanger 408 is also shown in elevation in FIG. 5 and comprises a planar surface 502 having approximately the same dimensions as the wide end 401 of the funnel-shaped casing 402 to which a face of a circuit board 204 (described below) is attached (after insulation using a suitable medium). In this embodiment the heat conductive, electrically insulating compound described above is used. The side of the heat exchanger 408 opposite the planar surface 502 comprises a plurality of raised tapering fins 410 which are arranged to partially project into the funnel-shaped casing 402. The tapering fins 410 are arranged to taper to provide a profile for the portion of the tapering fins 410 to be inserted into the funnel-shaped casing 402 which has a complementary shape to the inside of the narrowing funnel-shaped casing 402. The heat exchanger 408 is in thermal contact with funnel-shaped casing 402.

The second lighting module 400 further comprises a Light Emitting Diode (LED) array 202 arranged on the second face of the circuit board 204 mounted at a first face on the planar surface 502 of the conical heat exchanger 408 perpendicularly to a longitudinal axis of the second lighting module 400 such that in use the light produced by the LED array 202 is directed away from the funnel-shaped casing 402. The LED array 202 comprises a plurality of polymer encapsulated LED's as before but in this embodiment, one hundred and sixty five LED's are provided.

Roughly fifty five LED's are provided of each red (i.e. produce red light when a current is applied), blue and green. The light from the LED array 202 passes through an acrylic dust cover 206 which is bonded to conical heat exchanger 408 as in the first embodiment.

The fan 214 is arranged such that air is drawn into the portion of the tapering fins 410 of the conical heat exchanger 408 that protrude from the funnel-shaped casing 402. The air is then drawn through the portion of the tapering fins 410 of the heat exchanger 408 enclosed by the funnel-shaped casing 402, the funnel-shaped casing 402 acting as a duct. The air then passes through the fan 214 and is expelled into the atmosphere. Thus, the tapering fins 410 are cooled by air being drawn across them, which in turn removes heat from the circuit board 204 and the LED array 202 mounted on the circuit board 204.

Electronics to power the fan and the LED's of the second lighting module 400 are external to the module 400. A connection (not shown) is provided in the narrow end of the funnel-shaped housing 402 to which an external current source may be connected.

The principal purpose of the second lighting module 400 is to provide white light, and therefore the all the LED's of the LED array 202 will be lit to a common level of brightness at one time. The overall brightness of the second lighting module 400 could however be controlled using the principals described above.

A further embodiment of the present invention is shown in FIGS. 6 and 7, which show a linear lighting module 601 which may provide a linear spotlight. Such linear lighting modules are suitable for use as an architectural light source or similar areas.

The lighting module 601 comprises an aluminium extrusion 602 which provides an outer body and also acts as a heat sink. As can be seen from FIG. 6 the extrusion 601 can be approximated to a ‘U’ shape and the inner walls of the uprights of the ‘U’ each have a rebate 603 provided therein at roughly the mid point thereof. The rebates 603 provide a mechanical location into which a copper core circuit board 606 can be located.

A copper layer 604 provides a di-electric material as a central layer of the board 606. Holes are provided within the copper layer 604 so that pins of components (for example LEDs 608) can pass through the copper layer without contacting it. The components are soldered in a usual manner to the underside of the board (e.g. at 610).

As will be seen from FIG. 6 the copper layer 604 is expanded at edge regions 612,614 of the board 606 in order that the expanded portions can substantially fill the rebates 603 in order that good thermal contact can be made between the copper layer 604 and the extrusion 601. A void 605 is provided underneath the circuit board 606.

In use, as the LED's 608 and other components generate heat the copper layer 604 dissipates heat toward the aluminium extrusion, which also acts as a heat sink.

It will be appreciated that the use of the lighting module described above reduces the electrical energy required to produce the desired light. This is in itself advantageous, but has the further advantages that it has a long life (with a typical life of 100,000 hours), produces less heat (which in turn may reduce air conditioning requirements), requires no colour filters or periodic maintenance. Further, substantial savings may be achieved with power and distribution costs eliminating the need for remote dimmers, computer control and heavy gauge power distribution cables. It will be appreciated that LED's transmit virtually zero heat in the direction of light transmission.

It is envisaged that typical market applications for such lights include any of the following:

The retail environment, applications including window display illumination.
Including illumination of in store and external point of sale displays
Illumination of seasonal decorations.
In store accent lighting of architectural features such as ceilings, columns, walls, glazed lift shafts, water features, podium displays as well as illumination of shelving units.
Illumination of exhibition stands, product showrooms of all types including external and internal illumination of signs and information boards.

The built environment applications including the illumination both externally and internally of bridges, towers, buildings of architectural importance.
Places of worship, castles, railway stations,
Public buildings and commercial premises.
External and internal illumination of water features, flora and fauna displays such as the illumination of gardens.

The leisure environment applications including illumination of sports stadia, arenas, football grounds, recreation grounds.
Bars, public houses, private members clubs, night clubs, discotheques, health clubs gymnasiums, aerobic studios, bingo halls, casinos, racecourses.
Further applications include live performance venues such as theatres, concert venues, municipal halls, school halls and exhibition venues.
Other applications also include theme parks, fairground rides, amusement arcades, art galleries and museums, bowling alleys, water parks, and aquariums and cruise ships.
Further applications may also include the illumination of places of outstanding natural beauty such as caves, forests, cliff faces, monuments and pieces of public art and sculpture.

Photography, applications include the illumination of scenery, staging and performers within the film, television and still photographic markets. Either on location or studio based applications are possible.

Miscellaneous, The illumination of external locations, where coloured light or a changing coloured light may be used to help highlight a hazardous area. Applications include pedestrian crossings, zebra crossings and traffic junctions. As a suitable replacement for aircraft landing lights, using colour as a method of signalling.

1. A lighting module comprising a light source arranged to emit light and a cooling chamber being provided adjacent the light source with the cooling chamber being open to the atmosphere surrounding the lighting module, but substantially sealed from the light source.

2. The lighting module according to claim 1 in which the light source is arranged to emit light generally in front of a plane through the source.

3. The lighting module according to claim 1 in which the cooling chamber is arranged on a side of the light source substantially opposite the side which is generally arranged to emit light.

4. The lighting module according to claim 1 in which the cooling chamber has a heat sink arranged therein.

5. The lighting module according to claim 4 in which the heat sink is mounted on a wall of the lighting module, the wall being fabricated from a heat conducting material such that heat can be conducted to the wall.

6. The lighting module according to claim 5 in which the wall is fabricated from a metal.

7. The lighting module according to claim 5 in which the wall is an external wall of the lighting module.

8. The lighting module according to claim 5 in which the heat sink is sealed to the wall using a heat conductive sealing material.

9. The lighting module according to claim 8 in which the sealing material is a heat conductive rubber.

10. The lighting module according to claim 4 in which the heat sink has one or more cooling fins arranged thereon.

11. The lighting module according to claim 10 in which the light source is mounted on a surface of the heat sink, on a side opposite the one or more cooling fins.

12. The lighting module according to claim 11 in which the at least one cooling fin extends into the cooling chamber.

13. The lighting module according to claim 12 in which a fluid moving means is provided to assist the movement of fluid from outside of the lighting module into the cooling chamber.

14. The lighting module according to claim 13 in which a thermostat is provided and arranged to control the fluid moving means.

15. The lighting module according to claim 13 in which the cooling chamber is divided into an inlet and an outlet region by a plate or like member arranged across the cooling chamber.

16. The lighting module according to claim 15 in which the inlet region is arranged to intake fluid from the atmosphere surrounding the lighting module.

17. The lighting module according to claim 15 in which the outlet region is arranged to have fluid expelled therefrom to the atmosphere surrounding the lighting module.

18. The lighting module according to claim 15 in which the inlet region is arranged adjacent the heat sink.

19. The lighting module according to claim 15 in which the fluid moving means is arranged to move fluid from the inlet region to the outlet region.

20. The lighting module according to claim 15 in which the inlet region and outlet region are arranged such that, in the usual operating position of the lighting module, the outlet region is generally above the inlet region.

21. The lighting module according to claim 15 in which the cooling chamber is sealed from the light source to an appropriate Ingress Protection rating.

22. The lighting module according to claim 15 in which the lighting module comprises an electronics containing chamber arranged to contain electronics used in powering and controlling the light source.

23. The lighting module according to claim 22 in which the electronics chamber is sealed to an appropriate Ingress Protection rating.

24. The lighting module according to claim 22 in which the cooling chamber is between the light source and the electronics chamber.

25. A lighting module comprising a light source arranged to emit light and a cooling chamber, the light source being mounted adjacent an inlet region of the cooling chamber which is arranged to inlet cooling fluid and pass the cooling fluid to an outlet region wherein the inlet and outlet regions are arranged such that, in the usual operating position of the lighting module, the outlet region is generally above the inlet region.

26. The lighting module according to claim 25 which further comprises a fluid moving means arranged to move cooling fluid from the inlet region into the outlet region.

27. The lighting module according to claim 26 in which a thermostat is provided and arranged to control the fluid moving means.

28. The lighting module according to claim 25 in which the light source is mounted on a heat sink.

29. The lighting module according to claim 28 in which the heat sink has cooling fins that extend into the inlet region.

30. The lighting module according to claim 29 in which the cooling fins are arranged such that cooling fluid entering the inlet region passes over the cooling fins.

31. The lighting module according to claim 28 in which the heat sink is mounted on a wall of the lighting module fabricated from a heat conducting material such that heat can be conducted to the wall.

32. The lighting module according to claim 31 in which the wall is fabricated from a metal.

33. The lighting module according to claim 31 in which the wall is an external wall of the lighting module.

34. The lighting module according to claim 31 in which the heat sink is sealed to the wall using a heat conductive sealing material.

35. The lighting module according to claim 34 in which the sealing material is a heat conductive rubber.

36. The lighting module according to claim 25 in which the lighting module comprises an electronics containing chamber arranged to contain electronics used in powering and controlling the light source.

37. The lighting module according to claim 36 in which the cooling chamber is between the light source and the electronics chamber.

38. The lighting module according to claim 36 in which the electronics chamber contains a power supply unit.

39. The lighting module according to claim 38 in which the power supply unit is mounted upon a wall between the cooling chamber and the electronics chamber.

40. A lighting module according to claim 25 in which one or more holes is provided in an external wall of the lighting module, which communicate with the cooling chamber.

41. A lighting module according to claim 40 in which a portion of the or each hole is arranged to communicate with the inlet region, and a portion of the or each hole is arranged to communicate with the outlet region.

42. The lighting module according to claim 26 in which a plate is provided to substantially separate the inlet and outlet regions.

43. The lighting module according to claim 42 wherein the fluid moving means is provided within the plate.

44. A lighting module comprising a light source mounted upon a heat sink wherein the heat sink is mounted on a wall of the lighting module which is fabricated from a heat conducting material such that heat can be conducted to the wall.

45. The lighting module according to claim 44 in which the wall is an external wall of the lighting module.

46. The lighting module according to claim 44 in which the wall is fabricated from a metal.

47. The lighting module according to claim 44, in which the wall is fabricated from a heat conductive plastics material.

48. The lighting module according to claim 44 in which a fluid moving means is provided in order to move cooling fluid through the lighting module.

49. The lighting module according to claim 48 in which the fluid moving means is a fan, a pump, or the like.

50. The lighting module according claim 44 which comprises a spun aluminium body.

51. The lighting module according to claim 50 in which the body has a closed end and an open end through which light is transmitted.

52. The lighting module according to claim 44 in which the light source comprises an LED light source.

53. The lighting module according to claim 52 in which the LED light source comprises one or more of each of a red, green and blue LED.

54. The lighting module according to claim 53 in which the LED's are of the polymer encapsulated through hole type or of the surface mount type.

55. The lighting module according to claim 52 in which a controller is provided and arranged to control the light source.

56. The lighting module according to claim 55 in which the controller is arranged to vary the intensity of light emitted by any one colour of LED.

57. The lighting module according to claim 56 in which the controller is arranged to vary the intensity of a light by modulating the current supplied to the LED.

58. The lighting module according to claim 55 in which a user interface is provided allowing the controller to be manually programmed.

59. The lighting module according to claim 55 in which the controller is programmed from a device remote to the lighting module.

60. The lighting module according to claim 57 in which the controller is programmed with preprogrammed current control sequences thereby allowing the lighting module to generate fixed sequences of illumination.

61. The lighting module according to claim 55 which comprises a circuit board having a thermally conductive layer.

62. The lighting module according to claim 61 in which the thermally conductive layer is in thermal contact with a heat sink.

63. The lighting module according to claim 62 wherein the conductive layer is in thermal contact with a housing of the lighting module.

64. A lighting module comprising a light source mounted upon a circuit board wherein the circuit board comprises a heat conducting layer arranged to dissipate heat from the light source.

65. A lighting module according to claim 64 in which the heat conducting layer is thermally connected to a heat sink.

66. A lighting module according to claim 64 in which the heat sink comprises a housing of the lighting module.

67. A lighting module according to claim 64 in which the heat conducting layer comprises a metallic layer.

68. A lighting module according to claim 67 in which metallic layer is copper.

69. A lighting module according to claim 64 in which components are mounted on the circuit board such that they pass through the heat conducting layer without contacting it.

70. A lighting module according to claim 64 in which the housing of the heat sink comprises an extrusion.

71. A method of cooling a light source comprising mounting the light source adjacent a cooling chamber which is open to the atmosphere surrounding the lighting module, but substantially sealed from the light source.

72. A method of cooling a light source comprising providing a cooling chamber and mounting a light source adjacent thereto, and arranging the cooling chamber such that it comprises an inlet region adjacent the light source arranged to inlet cooling fluid and an outlet region arranged to expel cooling fluid and arranging the inlet and outlet region such that, in the usual operating position of the lighting module, the outlet region is generally above the inlet region.

73. A method of cooling a light source comprising mounting the light source upon a heat sink and further mounting the heat sink on a wall of a lighting module containing the light source and fabricating the wall from a heat conducting material such that heat can be conducted to the wall.

74. A lighting module substantially as described herein and as illustrated in the accompanying FIGS. 1 to 3.

75. A lighting module substantially as described herein and as illustrated in the accompanying FIG. 4.

76. A method of cooling a light source substantially as described herein and as illustrated in the accompanying FIGS. 1 to 3.

77. A method of cooling a light source substantially as described herein and as illustrated in the accompanying FIG. 4.
